(19) United States
(12) Patent Application Publication
(10) Pub. No.: US 2025/0391414 A1
(43) Pub. Date: Dec. 25, 2025

(54) AUDIO WIDENING UTILIZING METADATA

(71) Applicant: HARMAN BECKER AUTOMOTIVE SYSTEMS GmbH, Karlsbad-Ittersbach (DE)

(72) Inventors: Christopher OATES, Bamberg (DE); Alessandro TRAVAGLINI, Stuttgart (DE)

(21) Appl. No.: 19/213,626

(22) Filed: May 20, 2025

(30) Foreign Application Priority Data
Jun. 25, 2024 (EP) 24184258.2

(51) Int. Cl. G10L 19/008; G10L 19/16

(52) U.S. Cl. CPC G10L 19/008; G10L 19/173

(57) ABSTRACT

The application relates to a method carried out at an audio decoder, wherein a bitstream of compressed audio data including metadata is received by the audio decoder. In the metadata, at least one audio parameter is determined which influences a perception of an audio signal which is generated based on the bitstream and played out by a plurality of loudspeakers. The at least one audio parameter is amended in order to generate an amended bitstream, wherein an amended audio signal generated based on the amended bitstream leads to an amended perception compared to perception when the audio signal is played out by the loudspeakers based on the unamended bitstream. Furthermore, the amended bitstream is decoded for playback by the plurality of loudspeakers

### CROSS-REFERENCE TO RELATED APPLICATIONS

This application claims priority benefit to European Patent Application Number 24184258.2 entitled “AUDIO WIDENING UTILIZING METADATA”, filed Jun. 25, 2024, the contents of which are incorporated by reference herein in its entirety.

### BACKGROUND

### Field of the Various Embodiments

The present application relates to a method carried out at an audio decoder and relates to the audio decoder. Furthermore, a computer program comprising program code and a carrier comprising the computer program is provided.

### Description of the Related Art

During a mixing process of an audio signal the creation of an immersive listening experience is one important aspect. The aim of an immersive listening experience is a creation of a fully immersive and realistic audio experience for the listener where the sound is perceived as coming from different directions. One possibility for obtaining the immersive listening experience includes a widening process which aims at enhancing the stereo image or the perceived spatial distribution of sound, making it seem broader or more enveloping to the listener. Different methods are known in order to obtain audio signal widening such as Mid/Side processing which involves splitting a stereo signal into two components: Mid, which is the sum of the left and right channels (mono), and Side, which is the difference between the left and right channels. By manipulating these components—often by increasing the level of the Side component relative to the Mid component, a sense of greater width is created in the stereo field. Furthermore, specialized software tools or hardware tools are designed to manipulate the phase and level differences between stereo channels. Adjustments can be made to enhance or reduce the width of the audio signal. Some tools also allow for frequency-specific widening. In addition, it is possible to add different types or amounts of reverberation to the left and right channels so that a sense of spatial diversity and width is created.

However all these methods are expensive in terms of memory and processing power as different processing steps are needed such as transforming the audio signal into the frequency domain, apply various signal processing methods, and then transforming it back into the time domain.

Accordingly, a need exists to overcome the drawbacks mentioned above and to provide a processing option which provides an improved audio experience, especially for memory and power limited sound systems.

### SUMMARY

This need is met by the features of the independent claims. Further aspects are described in the dependent claims.

According to a first aspect a method carried out at an audio decoder is provided wherein a bitstream of compressed audio data including metadata is received by the audio decoder. In the metadata, at least one audio parameter is determined which influences a perception of an audio signal which is generated based on the bitstream and played out by a plurality of loudspeakers. The at least one audio parameter is amended in order to generate an amended bitstream, wherein an amended audio signal generated based on the amended bitstream leads to an amended perception compared to the perception when the audio signal is played out by the loudspeakers based on the unamended bitstream. Furthermore, the amended bitstream is decoded for playback by the plurality of loudspeakers.

Furthermore, the corresponding audio decoder is configured to operate as discussed above or as discussed in detail below.

The proposed method and the proposed decoder provide an efficient way to obtain the amended perception such as a widening of the perceived audio signal., such as the widening of the stereo image. The amending of the audio parameters in the metadata of the bitstream is a very computationally efficient way to achieve this amended perception compared to other methods for amending the perception or widening the perception which are carried out not on the compressed bitstream but at a later stage before the output by the loudspeakers where more complex processing steps such as Fourier transform, or other complex signal processing steps are necessary.

Furthermore, a computer program comprising program code is provided which, when executed by at least one processing unit of an audio decoder causes the at least one processing unit to carry out a method as discussed above or as discussed in further detail below.

Finally, a carrier is provided comprising the computer program, wherein the carrier is one of an electronic signal, optical signal, radio signal, and computer-readable storage medium.

It is to be understood that the features mentioned above and features yet to be explained below can be used not only in the respective combinations indicated, but also in other combinations or in isolation without departing from the scope of the present disclosure. Features of the above-mentioned aspects and embodiments described below may be combined with each other in other embodiments unless explicitly mentioned otherwise.

### BRIEF DESCRIPTION OF THE DRAWINGS

Other devices, systems, methods, features and advantages will be or will become apparent to one with skill in the art upon examination of the following detailed description and figures in which like reference numerals refer to like elements.

FIG. 1 shows a schematic view of processing steps carried out at a compressed audio signal where a widening of the audio perception is achieved in an effective way.

FIG. 2 shows a schematic view of a process carried out to identify whether a widening of the audio perception has been implemented or not.

FIG. 3 shows an example flowchart of some of the steps carried out in the audio decoder of FIG. 1.

FIG. 4 shows an example schematic representation of an audio decoder configured to amend a compressed bitstream in order to obtain an amended perception at a user.

### DETAILED DESCRIPTION

In the following, embodiments of the present disclosure will be described in detail with reference to the accompanying drawings. It is to be understood that the following description of embodiments is not to be taken in a limiting sense. The scope of the present disclosure is not intended to be limited by the embodiments described hereinafter or by the drawings, which are to be illustrative only.

The drawings are to be regarded as being schematic representations, and elements illustrated in the drawings are not necessarily shown to scale. Rather, the various elements are represented such that their function and general purpose becomes apparent to a person skilled in the art. Any connection or coupling between functional blocks, devices, components of physical or functional units shown in the drawings and described hereinafter may also be implemented by an indirect connection or coupling. A coupling between components may be established over a wired or wireless connection. Functional blocks may be implemented in hardware, software, firmware, or a combination thereof.

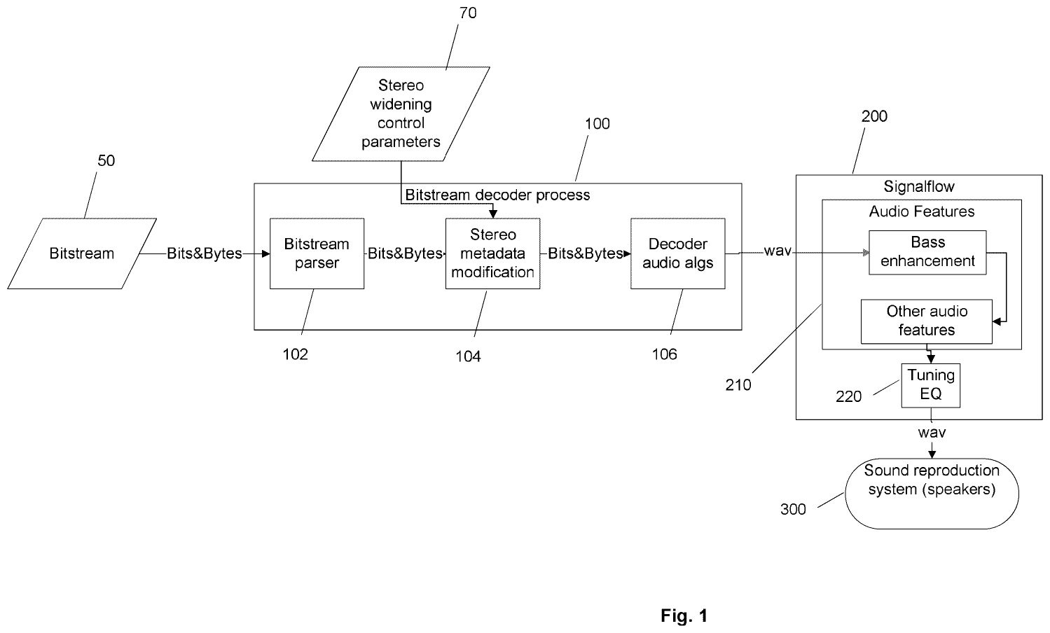

In the following a system and a method is described for modifying an audio bitstream to efficiently achieve a wider stereo image and which avoids executing existing and expensive stereo widening features. FIG. 1 shows a schematic view of a process for amending a bitstream of audio data wherein a bitstream 50 is received by an audio decoder 100. As discussed in detail below within the audio decoder the metadata are amended in such a way that a wider perception is obtained. After the decoder the bitstream is amended to a data format which could be played out by a sound reproduction system such as the loudspeaker 300. Before the output an optional further signal processing or enhancement unit 200 is provided where additional features and processing steps such as bass enhancement or other audio features and a tuning of the equalizer may be carried out. After the decoder 100 the audio signal is represented by numerical voltage values provided for audio playback.

In the following widening of the audio perception can mean that it is a widening of the stereo image, but it can also mean a widening of the spatial sound for an audio signal having 3 channels or more.

The bitstream 50 is an encoded audio file in a given format, by way of example MP4 using any codec such as xHE-AAC or any other codec which contains stereo coding. The bitstream can be generated by any codec which analyzes, parametrizes and transmits the stereo characteristics of the original stereo audio signal with the intention of using those stereo parameters to reconstruct the original stereo image from a mono-downmix of the original audio which is transmitted in the bitstream. Hence, for the purpose of stereo image reconstruction, the bitstream contains a mono-audio stream and a stereo parameter stream of binary data. An end-user requesting the bitstream could request the data from a streaming service such as Spotify or any other streaming service for reproduction by an audio system, by way of example in a vehicle or any other sound reproduction system.

The decoder 100 carries out the process of converting the stream of binary data back into a numerical value such as voltage values for audio playback or further processing. The audio decoder 100 comprises a bitstream parser 102 which reads and interprets the bitstream, the continuous sequence of binary digits, into numerical values which represents the audio content in the time-frequency domain and metadata which represents parametrized characteristics of the original audio. In the example of the xHE-AAC codec, the mono-downmix time-frequency domain data is generated by a modified discrete cosine transform, MDCT. The time-frequency data is segmented into frames, covering around 26 ms of audio, where each frame has corresponding stereo metadata including an Inter-channel Cross Correlation ICC, Inter-channel Level difference, ILD or Inter-channel Phase difference, IPD values over frequency. This is to say for each time-frequency frame of audio data there are K different ICC values or any other parameter where k represents the index of frequency row or frequency bins in the time-frequency grid of the audio representation.

$$ICC frame data = [ ICC ( k\_ 1 ) , ICC ( k\_ 2 ) , ICC ( k\_ 3 ) , … , ICC ( k\_K )$$

It should be understood that parameters such as a channel difference between 2 channels of the audio signal, the phase difference between channels and the cross correlation between channels is not restricted to the above identified codec, it generally applies to other compressed bitstreams of audio data. All these parameters can be manipulated to increase the perceived stereo width.

In the stereo metadata modification unit 104 a stereo parameter modification is carried out. Here the stereo parameters and their respective values are amended in order to obtain a certain target outcome. In this context control parameters 70 might be used which could be input by a user of the system or system designer or which might be preconfigured in a lookup table provided to the system. An end-user could be provided with a control option to increase or decrease the stereo widening effect. By way of example an increase of the ILD or the IPD results in an increase of the perceived width of the stereo image. This would be similar to having a dual mono stereo file and applying an equalization filter and/or an all-pass phase shifting filter to one of the channels to achieve a wider stereo image. A larger level difference and or phase difference between the channels will result also in a wider stereo image. An increase in the ICC will result in a perceived increase of the ambience of the sound. This is similar to adding a decorrelated version of the original audio to the mix to increase the sense of ambience. The higher the ratio of decorrelated signal to original signal, the higher the perceived ambient sound. Here it is possible to modify the parameters based on a percentage-based increase or decrease which is limited to a minimum or maximum value and position of the bitstream format. Lower bit rates have a coarser quantization of stereo parameter values and a maximum range of values they can represent in the binary format. It should be noted that no requirements for varying the parameters in relation to each other may exist. The different parameters may be changed independently and by different amounts with respect to each other.

By way of example the parameters could be set to increase linearly up to their maximum values or down to their minimum values. It is possible by controlling each parameter via a single increase stereo width/ambience controller which ranges from “dual-mono” to an operating mode such as “maximum stereo width or ambience”. As indicated above a number of parameters can exist and it is possible to apply a modification such as a constant modification across time and frequency for each of the audio frames. Furthermore, it is possible to select a limited frequency range for the modification so that not all the K-frequency rows need to be modified. Furthermore, it is possible that only the ICC values might be changed to simply increase the perception of ambience in the audio output.

After the modification of the metadata in unit 104 a decoding is carried out in the decoding unit 106. Here the encoding steps which created the bitstreams are inverted. In the present context this also means to go from mono audio to stereo. The steps are also outlined in ISO/IEC23003-3 standard. The decoding can work as follows:

The stereo output (L(eft) and R(ight)) is constructed via an up-mixing matrix applied to the mono audio (M[k,i]) and a decorrelated version of the mono audio (D[k,i]).

The weights of the up-mixing matrix are determined by the combination of the stereo parameters

[ [symbol] (L [symbol] k,i]@R [symbol] k,i])]=H[k,i][ [symbol] (M[k,i]@D[k,i])], where k and i are the frequency and time indexes respectively.

$$H = [ ◼ ( c\_l cos ( β + α ) \& c\_l cos ( β + α ) @ c\_r cos ( β - α ) \& c\_r cos ( β - α ) ,$$

$$where$$

$$c = 10 \hat{} ( ILD / 20 ) , c\_I = √ 2 c / √ ( 1 + c \hat{} 2 ) ,$$

$$c\_r = √ 2 / √ ( 1 + c \hat{} 2 ) , α = arc cos ( ICC ) / 2$$

$$β = arc tan ( tan ( α ) ( c\_r - c\_l ) / ( c\_r + c \_l ) )$$

Accordingly, referring to FIG. 1, an amended bitstream is generated after unit 104 as the metadata have been amended, after the decoding unit 106 an amended audio signal leaves decoder 100.

In a further processing or enhancement unit 210 processing of audio features can be provided including bass enhancement or other audio enhancement features. A stereo widening feature at this stage of the proceedings is not needed anymore as it is done in the compressed bitstream. Furthermore a tuning may be carried out in tuning unit 220. Summarizing, in unit 200 post-processing steps are carried out to deliver improved or tailored sound.

By way of example in an automotive domain this could be an acoustic system tuning including equalization delays and gains in any additional features like bass enhancement.

Other codecs might use other or different metrics to capture the stereo characteristics of the audio content. In these cases, the details of the parameters to be modified might be different but the principle of increasing and decreasing the metric used to reconstruct the stereo audio thereby modifying the perceived stereo image still applies.

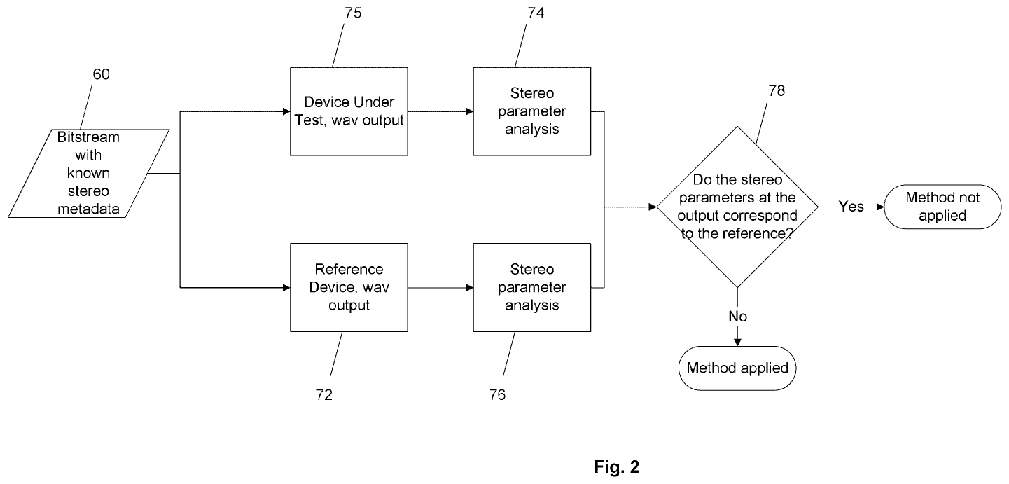

FIG. 2 shows a possible process how it can be detected whether the above parameter modification is carried out or not. A bitstream with known stereo metadata 60 is used which is fed to a device under test 75 and to a reference device 72. A stereo parameter analysis is carried out at 74 and 76 and in step 78 it is checked whether the stereo parameters at the output correspond to the reference. The reference device can be a standard decoder wherein all the decoder implementations are specified by an ISO standard. In this test, it is checked if the stereo-related parameters at the output of the device under test do not correspond to the parameters stored in the bitstream and to a reference decoder output. By way of example the Inter-channel Cross Correlation may be used. This is specified in the bitstream, and it can be measured on the decoder wav output. In the reference decoder implementation the bitstream metadata and measured ICC can be similar, if the output at the device under test is different, a system which modifies the stereo metadata is used.

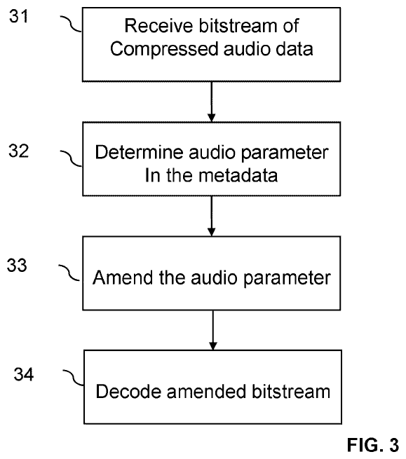

FIG. 3 summarizes some of the steps carried out in the process discussed in connection with FIG. 1. In step 31 bitstream of compressed audio data including metadata is received and in step 32 the metadata in the bitstream are determined and especially the audio parameter which influences a perception of an audio signal generated based on the bitstream and played out by loudspeakers. From the received bitstream one can follow which codec was used for the coding. Based on this information, it is possible to select or pick the audio parameters available in the bitstream. In step 33 the audio parameter is amended in order to generate an amended bitstream. The audio parameter can be an Inter-level difference between signal channels, a phase difference or a cross-correlation parameter. In step S34 the amended bitstream is decoded for playback.

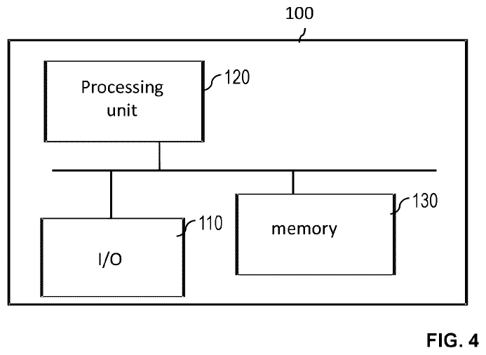

FIG. 4 shows a schematic architectural view of the decoder 100 which can carry out the above discussed amendment wherein FIG. 1 described the decoder in the context of functional units which carry out the different steps. The audio decoder can comprise an interface 110 configured to receive the bitstream and configured to output the decoded audio signal. The decoder 100 furthermore comprises a processing unit 120 which is responsible for the operation of the decoder 100. The processing unit 120 can comprise one or more processors and can carry out instructions stored on a memory 130, wherein the memory may include a read-only memory, a random-access memory, a mass storage, a hard disk or the like. The functional units shown in FIG. 1 may be implemented in processing unit 120. The memory can furthermore include a suitable program code to be executed by the processing unit 120 so as to implement the above-described functionalities in which the entity is involved.

From the above said some general conclusions can be drawn:
when the bitstream is amended, the amended perception can lead to an increased width perception compared to the width perception when the audio signal is played out by the loudspeakers based on the unamended bitstream.

The audio signal can be a multichannel audio signal and the at least one parameter encoded in the metadata can include an Inter-level difference such as a frequency dependent inter-level difference, between two channels. Here, the Inter-level difference may be increased in order to obtain an increased width perception. This may not describe signal value differences between the channels but could describe the differences over several frequency bands.

The parameter can include a cross-correlation parameter between two channels of the multichannel audio signal wherein the amendment of the audio parameter can mean an increase of the cross-correlation parameter in order to obtain the increased width perception.

The parameter can also include a phase difference between two channels of the multi-channel audio signal and increasing the phase difference can lead to an increased width perception. As mentioned in the context of the inter-level difference, this can include the differences over several frequency bands.

The at least one audio parameter may be amended based on a percentage-based amendment within a parameter range defined by minimum and maximum parameter value.

Furthermore, when the at least one audio parameter is amended it can mean that the audio parameter is increased linearly up to a maximum value or down to the minimum value.

The bitstream of compressed audio data can include k different frequency bins and the at least one audio parameter may be amended for each of the K frequency bins. In another embodiment it is also possible to amend the at least one parameter only for a subset of the K frequency bins.

The audio signal can be a stereo signal and the bitstream can then include stereo characteristics of the audio data.

As can be deduced from FIG. 1 the at least one audio parameter can be amended after the bitstream has passed through the parsing unit and before the bitstream is converted into voltage values for playback.

The present disclosure provides the following clauses:

1. A method carried out at an audio decoder, the method comprising:
receiving a bitstream of compressed audio data including metadata,
determining, in the metadata, at least one audio parameter influencing a perception of an audio signal generated based on the bitstream and played out by a plurality of loudspeakers,
amending the at least one audio parameter in order to generate an amended bitstream, wherein an amended audio signal generated based on the amended bitstream, played out by the plurality of loudspeakers leads to an amended perception compared to the perception when the audio signal is played out by the plurality of loudspeakers based on the unamended bitstream,
decoding the amended bitstream for playback by the plurality of loudspeakers.

2. The method of clause 1, wherein the amended bitstream, when played out by the plurality of loudspeakers, leads to an increased width perception compared to the width perception when the audio signal is played out by the plurality of loudspeakers based on the unamended bitstream.

3. The method of clause 2, wherein the audio signal is a multi-channel audio signal and the at least one audio parameter includes an inter level difference between 2 channels of the multi-channel audio signal, wherein amending the audio parameter comprises increasing the inter level difference in order to obtain the increased width perception.

4. The method of clause 2 or 3, wherein the audio signal is a multi-channel audio signal and the at least one audio parameter includes a cross-correlation parameter between 2 channels of the multi-channel audio signal, wherein amending the audio parameter comprises increasing the cross-correlation parameter in order to obtain the increased width perception.

5. The method of any of clauses 2 to 4, wherein the audio signal is a multi-channel audio signal and the at least one audio parameter includes a phase difference between 2 channels of the multi-channel audio signal, wherein amending the audio parameter comprises increasing the phase difference in order to obtain the increased width perception.

6. The method of any preceding clause, wherein the at least one audio parameter is amended based on a percentage-based amendment within a parameter range defined by a minimum and maximum parameter value.

7. The method of any preceding clause, wherein amending the at least one audio parameter comprises increasing the at least one audio parameter linearly up to a maximum value.

8. The method of any preceding clause, wherein the bitstream of compressed audio data includes k different frequency bins, wherein the at least one audio parameter is amended for each of the k frequency bins, with k being >1.

9. The method of any preceding clause, wherein the audio signal is a stereo signal, and the bitstream includes stereo characteristics of the audio signal.

10. The method of any preceding clause, wherein the at least one audio parameter is amended after the bitstream has passed through a bitstream parsing unit and before the bitstream is converted into voltage values for playback by a decoding unit.

11. An audio decoder comprising:
a parsing unit configured to receive a bitstream of compressed audio data including metadata
a modification unit configured to determine, in the metadata, at least one audio parameter influencing a perception of an audio signal generated based on the bitstream and played out by a plurality of loudspeakers, and to amend at least one audio parameter in order to generate an amended bitstream, wherein an amended audio signal generated based on the amended bitstream, played out by a plurality of loudspeakers leads to an amended perception compared to a the perception when the audio signal is played out by the plurality of loudspeakers,
a decoding unit configured to decode the amended bitstream for playback by the plurality of loudspeakers.

12. The audio decoder of claim 11, wherein the modification unit is configured to carry out a method as mentioned in any of clauses 2 to 10.

13. A computer program comprising program code, which when executed by at least one processing unit of an audio decoder, causes the at least one processing unit to carry out a method as mentioned in any of clauses 1 to 10.

14. A carrier comprising the computer program of clause 13, wherein the carrier is one of an electronic signal, optical signal, radio signal and computer readable storage medium.

Summarizing a method for unamended audio perception is provided which also works with limited memory and processing power. The disclosed embodiments can help to skip additional audio processing steps while still achieving control over the stereo image width. The stereo metadata parameters can be modified to modify the stereo image and no complex analysis and synthesis of the signal is needed.

What is claimed is:

1. A method carried out at an audio decoder, the method comprising:
receiving a bitstream of compressed audio data including metadata,
determining, in the metadata, at least one audio parameter influencing a perception of an audio signal generated based on the bitstream and played out by a plurality of loudspeakers,
amending the at least one audio parameter to generate an amended bitstream, wherein an amended audio signal generated based on the amended bitstream, played out by the plurality of loudspeakers leads to an amended perception compared to the perception when the audio signal is played out by the plurality of loudspeakers based on an unamended bitstream, and
decoding the amended bitstream for playback by the plurality of loudspeakers.

2. The method of claim 1, wherein the amended bitstream, when played out by the plurality of loudspeakers, leads to an increased width perception compared to a width perception when the audio signal is played out by the plurality of loudspeakers based on the unamended bitstream.

3. The method of claim 2, wherein the audio signal is a multi-channel audio signal and the at least one audio parameter includes an inter level difference, corresponding to one or more frequency bands, between two channels of the multi-channel audio signal, wherein amending the at least one audio parameter comprises increasing the inter level difference at the one or more frequency bands in order to obtain the increased width perception.

4. The method of claim 2, wherein the audio signal is a multi-channel audio signal and the at least one audio parameter includes a cross-correlation parameter between two channels of the multi-channel audio signal, wherein amending the at least one audio parameter comprises increasing the cross-correlation parameter to obtain the increased width perception.

5. The method of claim 2, wherein the audio signal is a multi-channel audio signal and the at least one audio parameter includes a phase difference between two channels of the multi-channel audio signal, wherein amending the at least one audio parameter comprises increasing the phase difference to obtain the increased width perception.

6. The method of claim 1, wherein the at least one audio parameter is amended based on a percentage-based amendment within a parameter range defined by a minimum and maximum parameter value.

7. The method of claim 1, wherein amending the at least one audio parameter comprises increasing the at least one audio parameter linearly up to a maximum value.

8. The method of claim 1, wherein the bitstream of compressed audio data includes k frequency bins, wherein the at least one audio parameter is amended for each of the k frequency bins, with k being greater than one.

9. The method of claim 1, wherein the audio signal is a stereo signal, and the bitstream includes stereo characteristics of the audio signal.

10. The method of claim 1, wherein the at least one audio parameter is amended after the bitstream has passed through a bitstream parsing unit and before the bitstream is converted into voltage values for playback by a decoding unit.

11. An audio decoder comprising:
a parsing unit configured to receive a bitstream of compressed audio data including metadata
a modification unit configured to determine, in the metadata, at least one audio parameter influencing a perception of an audio signal generated based on the bitstream and played out by a plurality of loudspeakers, and to amend the at least one audio parameter in order to generate an amended bitstream, wherein the amended audio signal generated based on the amended bitstream, played out by the plurality of loudspeakers leads to an amended perception compared to a the perception when the audio signal is played out by the plurality of loudspeakers based on an unamended bitstream, and
a decoding unit configured to decode the amended bitstream for playback by the plurality of loudspeakers.

12. The audio decoder of claim 11, wherein the audio signal is a multi-channel audio signal and the at least one audio parameter includes an inter level difference, corresponding to one or more frequency bands, between 2 channels of the multi-channel audio signal, wherein the modification unit is configured, for amending the at least one audio parameter, to carry out at least one of:
increasing the inter level difference at one or more frequency bands to obtain an increased width perception,
increasing a cross-correlation parameter to obtain the increased width perception, or
increasing a phase difference to obtain the increased width perception.

13. The audio decoder of claim 11, wherein the bitstream of compressed audio data includes k frequency bins, wherein the modification unit is configured to amend the at least one audio parameter for each of the k frequency bins, with k being greater than one.

14. One or more non-transitory computer-readable media storing instructions, which when executed by at least one processing unit of an audio decoder, causes the at least one processing unit to perform the steps of:
receiving a bitstream of compressed audio data including metadata,
determining, in the metadata, at least one audio parameter influencing a perception of an audio signal generated based on the bitstream and played out by a plurality of loudspeakers,
amending the at least one audio parameter to generate an amended bitstream, wherein an amended audio signal generated based on the amended bitstream, played out by the plurality of loudspeakers leads to an amended perception compared to the perception when the audio signal is played out by the plurality of loudspeakers based on an unamended bitstream, and
decoding the amended bitstream for playback by the plurality of loudspeakers.

15. The one or more non-transitory computer-readable media of claim 14, wherein the amended bitstream, when played out by the plurality of loudspeakers, leads to an increased width perception compared to a width perception when the audio signal is played out by the plurality of loudspeakers based on the unamended bitstream.

16. The one or more non-transitory computer-readable media of claim 15, wherein the audio signal is a multi-channel audio signal and the at least one audio parameter includes an inter level difference, corresponding to one or more frequency bands, between two channels of the multi-channel audio signal, wherein amending the at least one audio parameter comprises increasing the inter level difference at the one or more frequency bands in order to obtain the increased width perception.

17. The one or more non-transitory computer-readable media of claim 15, wherein the audio signal is a multi-channel audio signal and the at least one audio parameter includes a cross-correlation parameter between two channels of the multi-channel audio signal, wherein amending the at least one audio parameter comprises increasing the cross-correlation parameter to obtain the increased width perception.

18. The one or more non-transitory computer-readable media of claim 15, wherein the audio signal is a multi-channel audio signal and the at least one audio parameter includes a phase difference between two channels of the multi-channel audio signal, wherein amending the at least one audio parameter comprises increasing the phase difference to obtain the increased width perception.

19. The one or more non-transitory computer-readable media of claim 14, wherein the at least one audio parameter is amended based on a percentage-based amendment within a parameter range defined by a minimum and maximum parameter value.

20. The one or more non-transitory computer-readable media of claim 14, wherein amending the at least one audio parameter comprises increasing the at least one audio parameter linearly up to a maximum value.
